(19) United States
(12) Patent Application Publication
(10) Pub. No.: US 2024/0177917 A1
(43) Pub. Date: May 30, 2024

(54) POWER TRANSFORMERS AND MEDICAL DEVICES

(71) Applicant: SHANGHAI UNITED IMAGING HEALTHCARE CO., LTD., Shanghai (CN)

(72) Inventors: Qingchang CHEN, Shanghai (CN); Bobo WANG, Shanghai (CN); Xiaopeng LUO, Shanghai (CN)

(73) Assignee: SHANGHAI UNITED IMAGING HEALTHCARE CO., LTD., Shanghai (CN)

(21) Appl. No.: 18/430,642

(22) Filed: Feb. 1, 2024

Related U.S. Application Data
(63) Continuation of application No. PCT/CN2022/109645, filed on Aug. 2, 2022.

(30) Foreign Application Priority Data
Aug. 2, 2021 (CN) 202121782621.1
Sep. 28, 2021 (CN) 202122365740.3

(51) Int. Cl. H01F 27/26; H01F 27/28; H01F 38/14

(52) U.S. Cl. CPC H01F 27/263; H01F 27/2823; H01F 38/14

(57) ABSTRACT

The present disclosure relates to power transformers and medical devices having the same. A power transformer may include a first magnet comprising a first magnetic core and a first winding and a second magnet comprising a second magnetic core and a second winding wound around a side wall of the second magnetic core. The first magnetic core may include an annular body, and the first winding may be wound around a side wall of the annular body. The second magnetic core may include a groove extending from an end surface of the second magnetic core. The first magnet and the second magnet may be contactless. At least part of the annular body may be embedded in the groove. The first winding and the second winding may be at least partially overlapped along an axial direction of the second magnetic core.

### CROSS-REFERENCE TO RELATED APPLICATIONS

This application is a Continuation of International Application No. PCT/CN2022/109645, filed on Aug. 2, 2022, which claims priority to Chinese Patent Application No. 202121782621.1, filed on Aug. 2, 2021 and Chinese Patent Application No. 202122365740.3, filed on Sep. 28, 2021, the contents of which are incorporated herein by reference.

### TECHNICAL FIELD

The present disclosure generally relates to transformer technology, and more particularly, to power transformers and medical devices having the same.

### BACKGROUND

Medical devices, such as X-ray imaging devices, computed tomography (CT) imaging devices, positron emission tomography-computed tomography (PET-CT) devices, and radiation therapy devices, usually use power transformers for power transmission from a primary coil (winding) to a secondary coil (winding). However, existing power transformers often present problems such as magnetic leakage, low power transmission efficiency, and difficulty to manufacture. Therefore, it is desirable to provide power transformers that have reduced magnetic leakage, improved power transmission efficiency, and being easy to manufacture.

### SUMMARY

According to an aspect of the present disclosure, a power transformer is provided. The power transformer may include a first magnet comprising a first magnetic core and a first winding and a second magnet comprising a second magnetic core and a second winding wound around a side wall of the second magnetic core. The first magnetic core may include an annular body, and the first winding may be wound around a side wall of the annular body. The second magnetic core may include a groove extending from an end surface of the second magnetic core. The first magnet and the second magnet may be contactless. At least part of the annular body may be embedded in the groove. The first winding and the second winding may be at least partially overlapped along an axial direction of the second magnetic core.

According to another aspect of the present disclosure, a power transformer is provided. The power transformer may include a first magnet comprising a first magnetic core and a first winding; and a second magnet comprising a second magnetic core and a second winding. The first magnet and the second magnet may be contactless. The first magnetic core or the second magnetic core may include a plurality of magnetic units arranged in a circle.

According to yet another example, a medical device is provided. The medical device may include a power transformer according to some embodiments of the present disclosure.

Additional features will be set forth in part in the description which follows, and in part will become apparent to those skilled in the art upon examination of the following and the accompanying drawings or may be learned by production or operation of the examples. The features of the present disclosure may be realized and attained by practice or use of various aspects of the methodologies, instrumentalities and combinations set forth in the detailed examples discussed below.

### BRIEF DESCRIPTION OF THE DRAWINGS

The present disclosure is further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1 is a schematic diagram illustrating an exemplary medical device according to some embodiments of the present disclosure;

FIG. 2 is a block diagram illustrating an exemplary power transformer according to some embodiments of the present disclosure;

FIG. 3 is a schematic diagram illustrating an exemplary power transformer according to some embodiments of the present disclosure;

FIG. 4 is a schematic diagram illustrating an exemplary first magnet according to some embodiments of the present disclosure;

FIG. 5 is a schematic diagram illustrating an exemplary second magnet according to some embodiments of the present disclosure;

FIG. 6 is a vertical sectional view of an exemplary first magnetic core and an exemplary second magnetic core according to some embodiments of the present disclosure;

FIG. 7 is a vertical sectional view of an exemplary first magnetic core and an exemplary second magnetic core according to some embodiments of the present disclosure;

FIG. 8 is a vertical sectional view of an exemplary first magnetic core and an exemplary second magnetic core according to some embodiments of the present disclosure;

FIG. 9 is a vertical sectional view of an exemplary first magnetic core and an exemplary second magnetic core according to some embodiments of the present disclosure;

FIG. 10 is a vertical sectional view of an existing first magnetic core and an exemplary second magnetic core according to some embodiments of the present disclosure;

FIG. 11 is an expanded view of an exemplary magnet according to some embodiments of the present disclosure;

FIG. 12 is a top view of an exemplary magnet according to some embodiments of the present disclosure;

FIG. 13 is a side view of an exemplary magnetic core in a supporting piece according to some embodiments of the present disclosure;

FIG. 14 is a perspective view of two exemplary adjacent magnetic units according to some embodiments of the present disclosure;

FIG. 15 is a top view of an exemplary magnetic core according to some embodiments of the present disclosure;

FIG. 16 is a schematic diagram illustrating an exemplary magnetic core according to some embodiments of the present disclosure;

FIG. 17 is a top view of an exemplary magnetic core according to some embodiments of the present disclosure;

FIG. 18 is a perspective view of two exemplary adjacent magnetic units according to some embodiments of the present disclosure; and

FIG. 19 is a schematic diagram illustrating an exemplary magnetic core according to some embodiments of the present disclosure.

### DETAILED DESCRIPTION

In the following detailed description, numerous specific details are set forth by way of examples in order to provide a thorough understanding of the relevant disclosure. However, it should be apparent to those skilled in the art that the present disclosure may be practiced without such details. In other instances, well-known methods, procedures, systems, components, and/or circuitry have been described at a relatively high-level, without detail, in order to avoid unnecessarily obscuring aspects of the present disclosure. Various modifications to the disclosed embodiments will be readily apparent to those skilled in the art, and the general principles defined herein may be applied to other embodiments and applications without departing from the spirit and scope of the present disclosure. Thus, the present disclosure is not limited to the embodiments shown, but to be accorded the widest scope consistent with the claims.

The terminology used herein is for the purpose of describing particular example embodiments only and is not intended to be limiting. As used herein, the singular forms “a,” “an,” and “the” may be intended to include the plural forms as well, unless the context clearly indicates otherwise. It will be further understood that the terms “comprise,” “comprises,” and/or “comprising,” “include,” “includes,” and/or “including,” when used in this specification, specify the presence of stated features, integers, steps, operations, elements, and/or components, but do not preclude the presence or addition of one or more other features, integers, steps, operations, elements, components, and/or groups thereof.

It will be understood that the term “system,” “engine,” “unit,” “module,” and/or “block” used herein are one method to distinguish different components, elements, parts, section or assembly of different level in ascending order. However, the terms may be displaced by another expression if they achieve the same purpose.

Generally, the word “module,” “unit,” or “block,” as used herein, refers to logic embodied in hardware or firmware, or to a collection of software instructions. A module, a unit, or a block described herein may be implemented as software and/or hardware and may be stored in any type of non-transitory computer-readable medium or another storage device. In some embodiments, a software module/unit/block may be compiled and linked into an executable program. It will be appreciated that software modules can be callable from other modules/units/blocks or from themselves, and/or may be invoked in response to detected events or interrupts. Software modules/units/blocks configured for execution on computing devices may be provided on a computer-readable medium, such as a compact disc, a digital video disc, a flash drive, a magnetic disc, or any other tangible medium, or as a digital download (and can be originally stored in a compressed or installable format that needs installation, decompression, or decryption prior to execution). Such software code may be stored, partially or fully, on a storage device of the executing computing device, for execution by the computing device. Software instructions may be embedded in firmware, such as an EPROM. It will be further appreciated that hardware modules/units/blocks may be included in connected logic components, such as gates and flip-flops, and/or can be included of programmable units, such as programmable gate arrays or processors. The modules/units/blocks or computing device functionality described herein may be implemented as software modules/units/blocks, but may be represented in hardware or firmware. In general, the modules/units/blocks described herein refer to logical modules/units/blocks that may be combined with other modules/units/blocks or divided into sub-modules/sub-units/sub-blocks despite their physical organization or storage. The description may be applicable to a system, an engine, or a portion thereof.

It will be understood that when a unit, engine, module or block is referred to as being “on,” “connected to,” or “coupled to,” another unit, engine, module, or block, it may be directly on, connected or coupled to, or communicate with the other unit, engine, module, or block, or an intervening unit, engine, module, or block may be present, unless the context clearly indicates otherwise. As used herein, the term “and/or” includes any and all combinations of one or more of the associated listed items. The term “image” in the present disclosure is used to collectively refer to image data (e.g., scan data, projection data) and/or images of various forms, including a two-dimensional (2D) image, a three-dimensional (3D) image, a four-dimensional (4D), etc. The term “pixel” and “voxel” in the present disclosure are used interchangeably to refer to an element of an image.

It will be understood that, although the terms “first,” “second,” “third,” etc., may be used herein to describe various elements, these elements should not be limited by these terms. These terms are only used to distinguish one element from another. For example, a first element could be termed a second element, and, similarly, a second element could be termed a first element, without departing from the scope of example embodiments of the present invention.

Spatial and functional relationships between elements (for example, between layers) are described using various terms, including “connected,” “engaged,” “interfaced,” and “coupled.” Unless explicitly described as being “direct,” when a relationship between first and second elements is described in the present disclosure, that relationship includes a direct relationship where no other intervening elements are present between the first and second elements, and also an indirect relationship where one or more intervening elements are present (either spatially or functionally) between the first and second elements. In contrast, when an element is referred to as being “directly” connected, engaged, interfaced, or coupled to another element, there are no intervening elements present. Other words used to describe the relationship between elements should be interpreted in a like fashion (e.g., “between,” versus “directly between,” “adjacent,” versus “directly adjacent,” etc.).

These and other features, and characteristics of the present disclosure, as well as the methods of operation and functions of the related elements of structure and the combination of parts and economies of manufacture, may become more apparent upon consideration of the following description with reference to the accompanying drawings, all of which form a part of this disclosure. It is to be expressly understood, however, that the drawings are for the purpose of illustration and description only and are not intended to limit the scope of the present disclosure. It is understood that the drawings are not to scale.

An aspect of the present disclosure relates to power transformers. A power transformer may include a first magnet and a second magnet. In some embodiments, the first magnet may include a first magnetic core and a first winding. The second magnet may include a second magnetic core and a second winding wound around a side wall of the second magnetic core. In some embodiments, the first magnetic core may include an annular body, and the first winding may be wound around a side wall of the annular body. The second magnetic core may include a groove extending from an end surface of the second magnetic core. In some embodiments, the first magnet and the second magnet may be contactless. At least part of the annular body may be embedded in the groove, and the first winding and the second winding may be at least partially overlapped along an axial direction of the second magnetic core. In some embodiments, a material of the first magnetic core or the second magnetic core may be silicon steel. According to some embodiments of the present disclosure, the power transmission efficiency of the power transformer is high, and the power transformer is easy to manufacture. Further, the power transformer may be supplied with an AC power supply (e.g., a single-phase AC power supply or a three-phase AC power supply), and the power transformer may have a simple structure. In some embodiments, the first magnetic core or the second magnetic core may include a plurality of magnetic units arranged in a circle, and the plurality of magnetic units may be bonded via a thermally conductive adhesive. According to some embodiments of the present disclosure, the plurality of magnetic units are highly coupled. Thus, the power transmission efficiency of the power transformer is high, and there is no magnetic leakage of the power transformer.

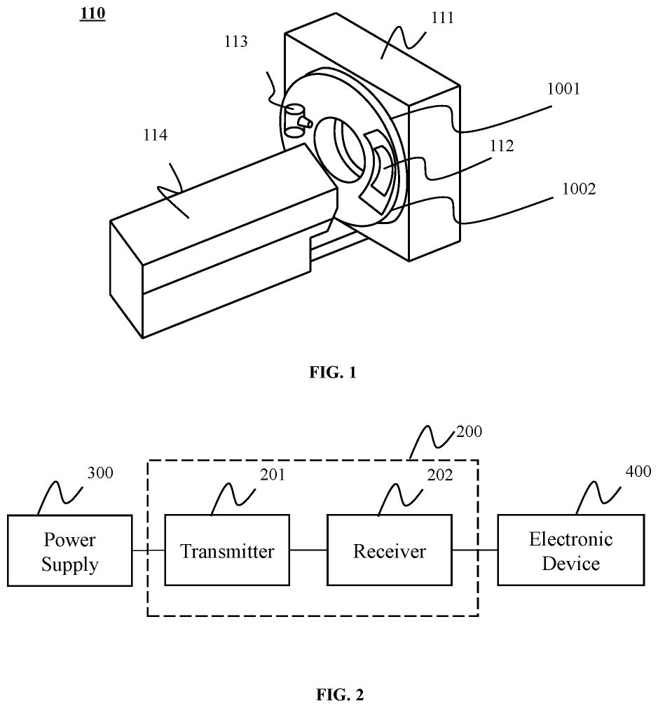

FIG. 1 is a schematic diagram illustrating an exemplary medical device 110 according to some embodiments of the present disclosure. In some embodiments, the medical device 110 may be include a single modality imaging device and/or a multi-modality imaging device. The single modality imaging device may include, for example, an X-ray imaging device, a computed tomography (CT) device, a radiation therapy device, or the like, or any combination thereof. The multi-modality imaging device may include, for example, an X-ray imaging-magnetic resonance imaging (X-ray-MRI) device, a positron emission tomography-X-ray imaging (PET-X-ray) device, a single photon emission computed tomography-magnetic resonance imaging (SPECT-MRI) device, a positron emission tomography-computed tomography (PET-CT) device, etc.

As illustrated in FIG. 1, the medical device 110 may include a gantry 111, a detector 112, a radiation source 113, and a scanning table 114. The detector 112 and the radiation source 113 may be oppositely mounted on the gantry 111. A subject may be placed on the scanning table 114 and moved into a detection tunnel (e.g., a space between the detector 112 and the radiation source 113) of the medical device 110. The subject may be biological or non-biological. Merely by way of example, the subject may include a patient, a man-made subject, etc. As another example, the subject may include a specific portion, organ, and/or tissue of the patient. For example, the subject may include head, brain, neck, body, shoulder, arm, thorax, cardiac, stomach, blood vessel, soft tissue, knee, feet, or the like, or any combination thereof. In the present disclosure, “subject” and “object” are used interchangeably.

The radiation source 113 may emit radiation rays to scan the subject that is placed on the scanning table 114. The radiation rays may include X-rays, γ-rays, α-rays, ultraviolet, laser, neutron, proton, or the like, or a combination thereof. The detector 112 may receive the radiation rays passed through the subject. In some embodiments, the detector 112 may include a plurality of detector units, which may be arranged in a channel direction and a row direction. The detector 112 may include a scintillation detector (e.g., a cesium iodide detector) or a gas detector.

The gantry 111 may include a fixed portion 1001 and a rotation portion 1002. In some embodiments, the medical device 110 may further include a power transformer (not shown in FIG. 1) for providing power for the medical device 110. The power transformer may be configured to transmit power from a primary winding to a secondary winding with no physical connection between the primary winding and the secondary winding. For example, the primary winding of the power transformer may be mounted on the fixed portion 1001 and the secondary winding of the power transformer may be mounted on the rotation portion 1002. The power transformer may transmit power from the fixed portion 1001 to the rotation portion 1002. More descriptions regarding the power transformer may be found elsewhere in the present disclosure. See, e.g., FIGS. 2-19, and relevant descriptions thereof.

It should be noted that the above description of the medical device 110 is intended to be illustrative, and not to limit the scope of the present disclosure. Many alternatives, modifications, and variations will be apparent to those skilled in the art. The features, structures, methods, and other characteristics of the exemplary embodiments described herein may be combined in various ways to obtain additional and/or alternative exemplary embodiments. For example, the medical device 110 may include one or more additional components. Additionally or alternatively, one or more components of the medical device 110 described above may be omitted. For example, the medical device 110 may include a storage device configured to store information regarding the medical device 110. The storage device may be an independent device, or be part of the medical device 110. As still another example, the power transformer may be used in any electronic devices but not limited to the medical device 110.

FIG. 2 is a block diagram illustrating an exemplary power transformer 200 according to some embodiments of the present disclosure. As shown in FIG. 2, the power transformer 200 may include a transmitter 201 and a receiver 202. In some embodiments, the transmitter 201 may be configured to connect a power supply 300 and transmit power to the receiver 202. The receiver 202 may be configured to receive the power from the transmitter 201, and connect an electronic device 400. In some embodiments, the electronic device 400 may be a device that requires electricity. For example, the electronic device 400 may be a component (e.g., a high voltage generator, a bulb tube, the gantry 111, etc.) of the medical device 110.

In some embodiments, the transmitter 201 or the receiver 202 may include a magnet (e.g., a first magnet or a second magnet described elsewhere in the present disclosure). The magnet may include a magnetic core (e.g., a first magnet core or a second magnet core described elsewhere in the present disclosure) and a winding (e.g., a first winding or a second winding described elsewhere in the present disclosure) wound around the magnetic core. In some embodiments, a winding of the transmitter 201 may connect the power supply 300 (e.g., the AC power supply), and a winding of the receiver 202 may connect electronic device 400.

In some embodiments, the transmitter 201 may be fixed and the receiver 202 may be rotatable relative to the transmitter 201. Alternatively, the receiver 202 may be fixed and the transmitter 201 may be rotatable relative to the receiver 202.

In some embodiments, the power supply 300 may include an alternating current (AC) power supply, a direct current (DC) power supply, etc. Exemplary AC power supply may include a single-phase AC power supply, a three-phase AC power supply, etc. In some embodiments, a power frequency of the AC power supply may be within a range from 20 Hz to 200 Hz. For example, the power frequency of the single-phase AC power supply or the three-phase AC power supply may be 50 Hz or 60 Hz.

According to some embodiments of the present disclosure, the power transformer 200 may be directly supplied by the AC power supply without DC conversion from the AC power supply. Thus, a circuit complexity of the power transformer 200 (or the medical device 100 including the power transformer 200) may be reduced.

It should be noted that the above description of power transformer 200 is intended to be illustrative, and not to limit the scope of the present disclosure. Many alternatives, modifications, and variations will be apparent to those skilled in the art. The features, structures, methods, and other characteristics of the exemplary embodiments described herein may be combined in various ways to obtain additional and/or alternative exemplary embodiments. For example, the power transformer 200 may include one or more additional components (e.g., a magnetic core, a winding, etc.) not shown in FIG. 2.

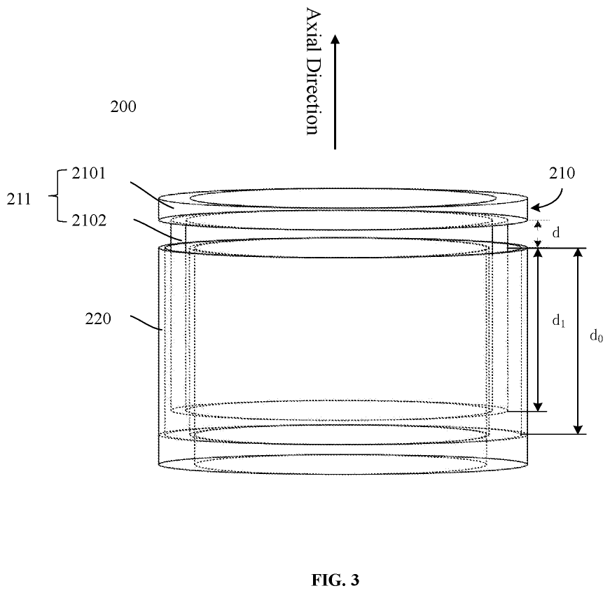

FIG. 3 is a schematic diagram illustrating an exemplary power transformer 200 according to some embodiments of the present disclosure. As shown in FIG. 3, the power transformer 200 may include a first magnet 210 and a second magnet 220. In some embodiments, when the first magnet 210 is the transmitter 201, the second magnet may be the receiver 202. When the second magnet is the transmitter 201, the first magnet may be the receiver 202.

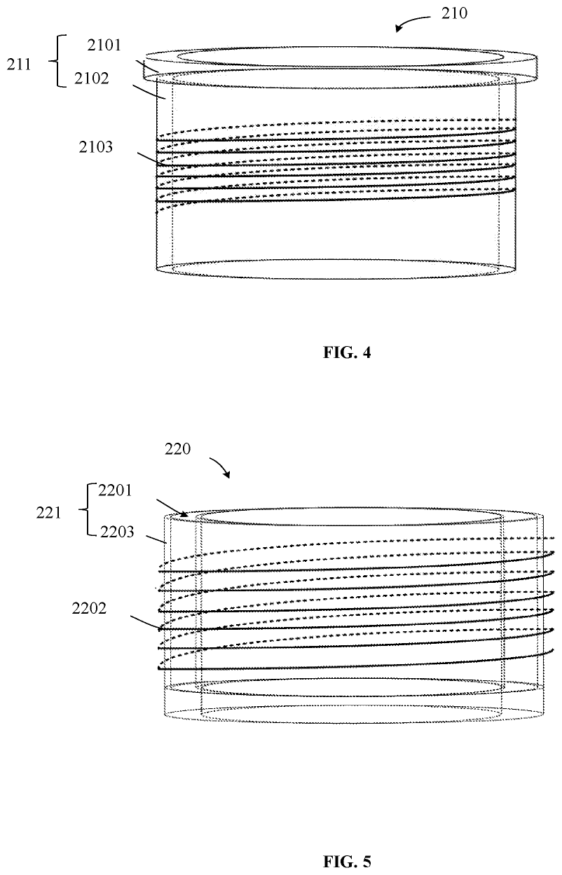

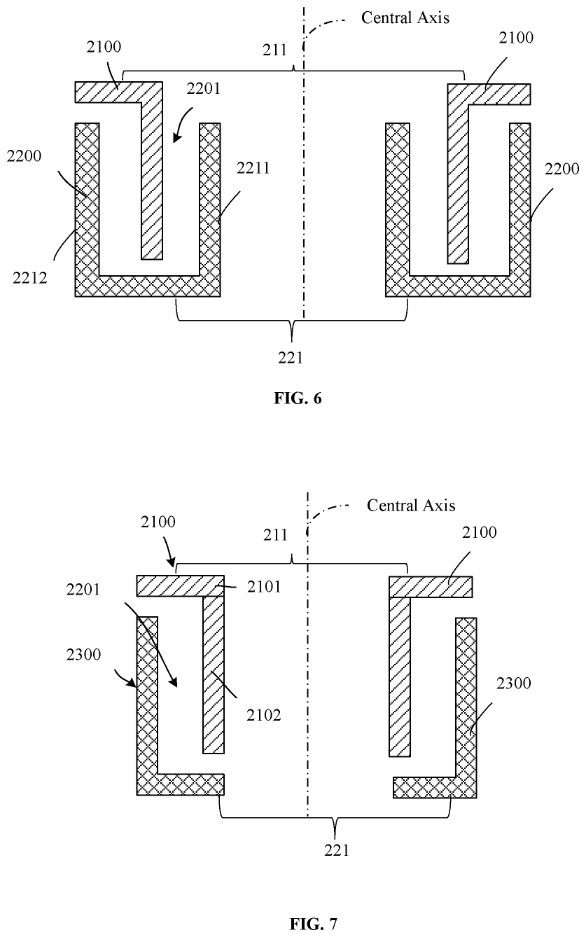

FIG. 4 is a schematic diagram illustrating an exemplary first magnet 210 according to some embodiments of the present disclosure. FIG. 5 is a schematic diagram illustrating an exemplary second magnet 220 according to some embodiments of the present disclosure. As shown in FIG. 3 and FIG. 4, the first magnet 210 may include a first magnetic core 211 and a first winding 2103. The first magnetic core 211 may include an annular body 2102. More descriptions regarding the first magnetic core 211 may be found elsewhere in the present disclosure. See, e.g., FIGS. 6-19, and relevant descriptions thereof.

In some embodiments, the annular body 2102 may include an inner annular body and an outer annular body. The inner annular body may be close to a central axis of the first magnetic core 211, and the outer annular body may be away from the central axis of the first magnetic core 211. As used herein, the central axis of the first magnetic core 211 (or the annular body 2102) may be a line connecting multiple centers each of which is a center of each circular cross section of the annular body 2102.

In some embodiments, the first winding 2103 may be wound around a side wall of the annular body 2102. For example, the first winding 2103 may be wound around a side wall of the inner annular body. As another example, the first winding 2103 may be wound around a side wall of the outer annular body 2102. In some embodiments, the side wall may include an inner side wall and an outer side wall. The inner side wall may be close to the central axis of the annular body 2102, and the outer side wall may be away from the central axis of the annular body 2102. For example, to facilitate the manufacture of the first magnet 210, the first winding 2103 may be wound around the outer side wall of the outer annular body 2102.

As shown in FIG. 3 and FIG. 5, the second magnet 220 may include a second magnetic core 221 and a second winding 2202. The second winding 2202 may be wound around a side wall of the second magnetic core 221. For example, as shown in FIG. 5, the second winding 2202 may be wound around an outer side wall of the second magnetic core 221.

In some embodiments, the second magnetic core 221 may include a groove 2201 extending from an end surface of the second magnetic core 221. For example, an opening of the groove 2201 may be at the end surface (e.g., a top surface shown in FIG. 5) of the second magnetic core 221. The groove 2201 may be configured to accommodate at least part of the first magnet 210, so that the first magnet 210 may insert into the second magnet 220. For example, at least part of the annular body 2102 may be embedded in the groove 2201. More descriptions regarding the second magnetic core 221 may be found elsewhere in the present disclosure. See, e.g., FIGS. 6-19, and relevant descriptions thereof.

In some embodiments, the first winding 2103 and the second winding 2202 may be at least partially overlapped along an axial direction of the second magnetic core 221. As used herein, the axial direction of the second magnetic core 221 may be an extension direction of a central axis of the second magnetic core 221. According to some embodiments of the present disclosure, the first magnet 210 being inserted into the second magnet 220 and the first winding 2103 and the second winding 2202 being at least partially overlapped along the axial direction may reduce a size of the power transformer 200 and improve the power transmission efficiency of the power transformer 200.

In some embodiments, the first winding 2103 and/or the second winding 2202 may be covered by an insulating material, such as but not limited to insulating resin. For example, the first winding 2103 may be firstly covered by the insulating resin, and then wound around a side wall of the first magnetic core 211. As another example, the second winding 2202 may be firstly covered by the insulating resin, and wound around a side wall of the second magnetic core 221.

In some embodiments, a material of the first magnetic core 211 and/or the second magnetic core 221 may include silicon steel. The material of existing magnetic cores is soft magnetic material. Compared with soft magnetic material, the silicon steel may reduce a manufacture difficulty and reduce manufacture cost of the power transformer 200.

As shown in FIG. 3 and FIG. 4, the first magnetic core 211 may further include an annular plate 2101. The annular plate 2101 may be configured to facilitate positioning and installation of the first magnet 210. In some embodiments, the first magnetic core 211 and the second magnetic core 221 may be coaxial. For example, a central axis of the second magnetic core 221 may be coincided with the central axis of the first magnetic core 211. As used herein, the central axis of the second magnetic core 221 may be a line connecting multiple centers each of which is a center of each circular cross section of the second magnetic core 221. In some embodiments, the annular plate 2101, the annular body 2102, and the second magnetic core 221 may be coaxial. Thus, the axial directions of the annular plate 2101, the annular body 2102, and the second magnetic core 221 may be the same. As shown in FIG. 3, an outer diameter of the annular plate 2101 may be greater than an outer diameter of the annular body 2102.

In some embodiments, the annular plate 2101 may be disposed on a top end of the annular body 2102. A bottom end of the annular body 2102 may be embedded in the groove 2201 of the second magnetic core 221. In some embodiments, the top end and the bottom end of the annular body 2102 may be two opposite ends at circular ends of the annular body 2102.

In some embodiments, the first magnet 210 and the second magnet 220 may be contactless. For example, as shown in FIG. 3, a distance d between a bottom surface of the annular plate 2101 and an end surface of the second magnetic core 221 may be greater than 0. The outer side wall of the annular body 2102 may not contact with an inner side wall of second magnetic core 221, and a bottom surface of the annular body 2102 may not contact with an inner surface of the groove 2201. In some embodiments, a depth d₀ of the groove 2201 may be greater than a sum of the distance d and an insert depth d₁ of the annular body 2102. The insert depth d₁ may refer to a length of a part of the annular body 2102 that inserts into the groove 2201 along an axial direction of the first magnet 210. As used herein, the axial direction of the first magnet 210 may be an extension direction of the central axis of the first magnetic core 211 (or the annular body 2102). As another example, a height of the annular body 2102 (i.e., a sum of the distance d and the insert depth d₁) may be less than the depth do of the groove 2201.

In some embodiments, a width of a gap between the first magnetic core 211 and the second magnetic core 221 may be determined based on roughness of two surfaces of the first magnetic core 211 and the second magnetic core 221 that form the gap. As used herein, the width of the gap between the first magnetic core 211 and the second magnetic core 221 may refer to a shortest distance between the first magnetic core 211 and the second magnetic core 221 along a radial direction. The radial direction may be a direction of a diameter of a circular cross section of the annular body 2102 (or the second magnet 220). The radial direction may be perpendicular to the axial direction. In some embodiments, the less roughness of two surfaces of the first magnetic core 211 and the second magnetic core 221 that form the gap, the less width of the gap. In some embodiments, to reduce the width of the gap for improving the power transmission efficiency of the power transformer 200, the roughness of two surfaces of the first magnetic core 211 and the second magnetic core 221 that form the gap may be as small as possible.

In some embodiments, the first magnetic core 211 and/or the second magnetic core 221 may include a plurality of magnetic units arranged in a circle. More descriptions regarding the arrangements of the plurality of magnetic units may be found elsewhere in the present disclosure. See, e.g., FIGS. 11-19, and relevant descriptions thereof.

FIG. 6 is a vertical sectional view of an exemplary first magnetic core 211 and an exemplary second magnetic core 221 according to some embodiments of the present disclosure. As shown in FIG. 6, the first magnetic core 211 may include a plurality of first L-shaped magnetic units 2100 arranged in a circle. In some embodiments, a pair of first L-shaped magnetic units 2100 may be symmetric with respect to the central axis of the first magnetic core 211 (or the second magnetic core 221). In some embodiments, long ends of the plurality of first L-shaped magnetic units 2100 may form the annular body 2102, and short ends of the plurality of first L-shaped magnetic units 2100 may form the annular plate 2101. As used herein, a long end and a short end of a first L-shaped magnetic unit 2100 may refer to a long segment and a short segment of a letter “L” representing the first L-shaped magnetic unit 2100. As shown in FIG. 6, a terminal point of a short end of each first L-shaped magnetic unit 2100 that is not connected to the corresponding long end of the first L-shaped magnetic unit 2100 may face toward away from the central axis. The long ends of the plurality of first L-shaped magnetic units 2100 are parallel to the central axis and the short ends of the plurality of first L-shaped magnetic units 2100 are perpendicular to the central axis. In some embodiments, the first winding 2103 may be wound around the side wall (e.g., the inner side wall, the outer side wall) of the outer annular body 2102. For example, the first winding 2103 may be wound around a side wall that is spliced by the long ends of the plurality of first L-shaped magnetic units 2100.

As shown in FIG. 6, the second magnetic core 221 may include a plurality of first U-shaped magnetic units 2200 arranged in a circle. In some embodiments, a pair of first U-shaped magnetic units 2200 may be symmetric with respect to the central axis of the first magnetic core 211 (or the second magnetic core 221). In some embodiments, the plurality of first U-shaped magnetic units 2200 may form the groove 2201. For example, U-shaped grooves of the plurality of first U-shaped magnetic units 2200 may be arranged in a circle to form the groove 2201. Each first U-shaped magnetic unit 2200 may include an inner end 2211 and an outer end 2212. The inner end 2211 may be parallel to the outer end 2212. The inner end 2211 may be further away from the central axis than the corresponding outer end 2212. As used herein, an inner end 2211 and an outer end 2212 correspond to each other may refer that the two parallel plates belong to a same first U-shaped magnetic unit 2200. In some embodiments, a plurality of inner ends 2211 of the plurality of first U-shaped magnetic units 2200 may form an inner ring of the second magnetic core 221, and a plurality of outer ends 2212 of the plurality of first U-shaped magnetic units 2200 may form an outer ring of the second magnetic core 221.

In some embodiments, the second winding 2202 may be wound around a side wall (e.g., an inner side wall) of the groove 2201 of the second magnetic core 221. In some embodiments, the second winding 2202 may be wound around a side wall (e.g., an outer side wall) of the inner ring of the second magnetic core 221. In some embodiments, the second winding 2202 may be wound around a side wall (e.g., an inner side wall, an outer side wall) of the outer ring of the second magnetic core 221.

In some embodiments, each of the plurality of first L-shaped magnetic units 2100 may have a same size or a different size. For example, to facilitate the manufacture of the first magnetic core 211, the plurality of first L-shaped magnetic units 2100 may have a same size. In some embodiments, each of the plurality of plurality of first U-shaped magnetic units 2200 may have a same size or a different size. For example, to facilitate the manufacture of the second magnetic core 221, the plurality of first U-shaped magnetic units 2200 may have a same size.

FIG. 7 is a vertical sectional view of an exemplary first magnetic core 211 and an exemplary second magnetic core 221 according to some embodiments of the present disclosure. As shown in FIG. 7, the first magnetic core 211 may include a plurality of first L-shaped magnetic units 2100 arranged in a circle. More descriptions regarding the plurality of first L-shaped magnetic units 2100 and the first winding 2103 may be found elsewhere in the present disclosure. See, e.g., FIG. 6 and relevant descriptions thereof.

As shown in FIG. 7, the second magnetic core 221 may include a plurality of second L-shaped magnetic units 2300 arranged in a circle. In some embodiments, a pair of second L-shaped magnetic units 2300 may be symmetric with respect to the central axis of the first magnetic core 211 (or the second magnetic core 221). In some embodiments, the plurality of second L-shaped magnetic units 2300 may form the groove 2201. For example, long ends of the plurality of second L-shaped magnetic units 2300 and short ends of the plurality of second L-shaped magnetic units 2300 may form the groove 2201. As shown in FIG. 7, an opening of the groove 2201 may face towards the central axis. An outer side wall of the annular body 2102 may face towards an inner side wall of the second magnetic core 221. A bottom surface of the annular body 2102 may be on the top of the short ends of the plurality of second L-shaped magnetic units 2300.

In some embodiments, the second winding 2202 may be wound around a side wall of the groove 2201 of the second magnetic core 221. For example, the second winding 2202 may be wound around a side wall that is spliced by the long ends of the plurality of second L-shaped magnetic units 2300. As another example, the plurality of second L-shaped magnetic units 2300 may be arranged in a circle to form a circular cylinder. The second winding 2202 may be wound around an inner side wall or an outer side wall of the circular cylinder.

In some embodiments, each of the plurality of second L-shaped magnetic units 2300 may have a same size or a different size. For example, to facilitate the manufacture of the second magnetic core 221, the plurality of second L-shaped magnetic units 2300 may have a same size. In some embodiments, a size of each of the plurality of plurality of first L-shaped magnetic units 2100 and a size of each of the plurality of second L-shaped magnetic units 2300 may be same or different. For example, to facilitate the manufacture of the power transformer 200, the size of each of the plurality of plurality of first L-shaped magnetic units 2100 and the size of each of the plurality of second L-shaped magnetic units 2300 may be same.

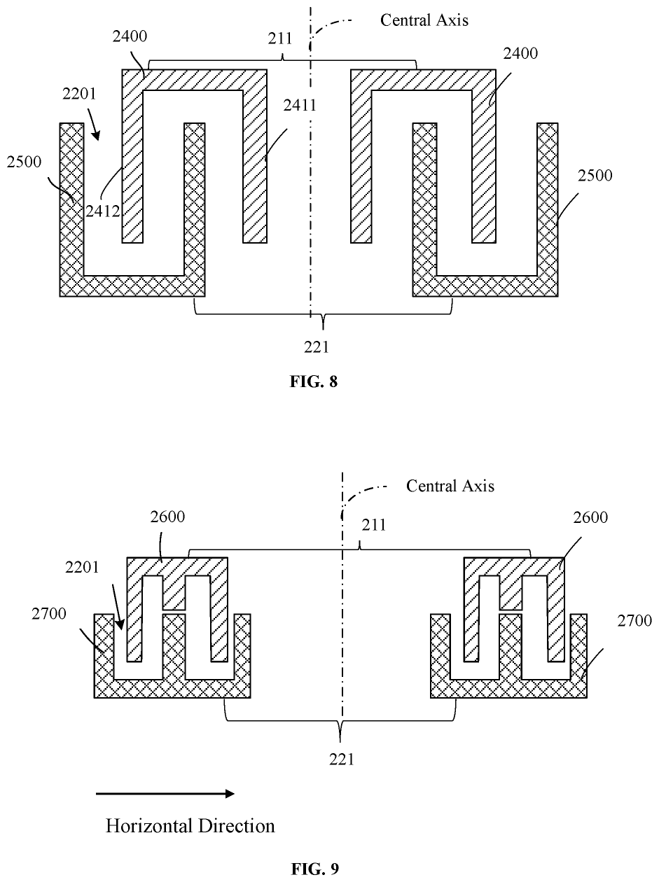

FIG. 8 is a vertical sectional view of an exemplary first magnetic core 211 and an exemplary second magnetic core 221 according to some embodiments of the present disclosure. As shown in FIG. 8, the first magnetic core 211 may include a plurality of second-shaped magnetic units 2400 arranged in a circle. Inner ends of the plurality of second U-shaped magnetic units 2400 may form an inner annular body of the annular body 2102, and outer ends of the plurality of second U-shaped magnetic units 2400 may form an outer annular body of the annular body 2102.

Each second U-shaped magnetic unit 2400 may include an inner end 2411 and an outer end 2412. The inner end 2411 may be parallel to the outer end 2412. The inner end 2411 may be further away from the central axis than the corresponding outer end 2412. As used herein, an inner end 2411 and an outer end 2412 correspond to each other may refer that the two parallel plates belong to a same second U-shaped magnetic unit 2400. In some embodiments, a plurality of inner ends 2411 of the plurality of second U-shaped magnetic units 2400 may form an inner annular body of the annular body 2102, and a plurality of outer ends 2412 of the plurality of second U-shaped magnetic units 2400 may form an outer annular body of the annular body 2102. In some embodiments, the first winding 2103 may be wound around a side wall (e.g., an outer side wall) of the inner annular body or a side wall (e.g., an outer side wall) of the outer annular body.

As shown in FIG. 8, the second magnetic core 221 may include a plurality of third U-shaped magnetic units 2500 arranged in a circle. In some embodiments, a pair of third U-shaped magnetic units 2500 may be symmetric with respect to the central axis of the first magnetic core 211 (or the second magnetic core 221). In some embodiments, the plurality of third U-shaped magnetic units 2500 may form the groove 2201. The inner annular body or the outer annular body of the annular body 2102 may be embedded in the groove 2201. In some embodiments, the plurality of third U-shaped magnetic units 2500 may be same or similar to the plurality of first U-shaped magnetic units 2200 described in FIG. 6 of the present disclosure. More descriptions regarding plurality of third U-shaped magnetic units 2500 and the second winding 2202 may be found elsewhere in the present disclosure. See, e.g., FIG. 6 and relevant descriptions thereof.

In some embodiments, each of the plurality of second U-shaped magnetic units 2400 may have a same size or a different size. For example, to facilitate the manufacture of the second magnetic core 221, the plurality of second U-shaped magnetic units 2400 may have a same size. In some embodiments, each of the plurality of third U-shaped magnetic units 2500 may have a same size or a different size. For example, to facilitate the manufacture of the second magnetic core 221, the plurality of third U-shaped magnetic units 2500 may have a same size. In some embodiments, a size of each of the plurality of plurality of second U-shaped magnetic units 2400 and a size of each of the plurality of third U-shaped magnetic units 2500 may be same or different. For example, to facilitate the manufacture of the power transformer 200, the size of each of the plurality of plurality of second U-shaped magnetic units 2400 and the size of each of the plurality of third U-shaped magnetic units 2500 may be same.

FIG. 9 is a vertical sectional view of an exemplary first magnetic core 211 and an exemplary second magnetic core 221 according to some embodiments of the present disclosure. As shown in FIG. 9, the first magnetic core 211 may include a plurality of first E-shaped magnetic units 2600 arranged in a circle. The second magnetic core 221 may include a plurality of second E-shaped magnetic units 2700 arranged in a circle. In some embodiments, each first E-shaped magnetic unit 2600 (or second E-shaped magnetic unit 2700) may include two side columns and an intermediate column. As used herein, the two side columns may refer to two horizontal line segments on the top and bottom of the letter “E” representing the first E-shaped magnetic units 2600 or the second E-shaped magnetic unit 2700. The intermediate column may refer to a horizontal line segments at the middle of the letter “E” representing the first E-shaped magnetic units 2600 or the second E-shaped magnetic unit 2700. The two side columns and the intermediate column of each first E-shaped magnetic unit 2600 (or second E-shaped magnetic unit 2700) form two openings (or referred to as slots) of the first magnetic core 211 (or the second magnetic core 221). In some embodiments, two openings (or referred to as slots) of a first E-shaped magnetic unit 2600 may face towards two openings (or referred to as slots) of a corresponding second E-shaped magnetic unit 2700. In some embodiments, a width of the first magnetic core 211 may be less than a width of the second magnetic core 221. The width of the first magnetic core 211 (or the second magnetic core 221) may be a length of the first magnetic core 211 (or the second magnetic core 221) along a horizontal direction. The horizontal direction may be perpendicular to the central axis. As shown in FIG. 9, two side columns of a first E-shaped magnetic unit 2600 may be embedded into two openings (or referred to as slots) of the corresponding second E-shaped magnetic unit 2700. Alternatively, the width of the first magnetic core 211 may be greater than the width of the second magnetic core 221. For example, two side columns of a second E-shaped magnetic unit 2700 may be embedded into two openings (or referred to as slots) of the corresponding first E-shaped magnetic unit 2600.

In some embodiments, as shown in FIG. 9, two openings (or referred to as slots) of each of the plurality of second E-shaped magnetic units 2700 may be arranged in a circle to form the groove 2201. The plurality of first E-shaped magnetic units 2600 arranged in a circle may form an inner annular body, an intermediate annular body, and an outer annular body of the annular body 2102. The inner annular body and/or the outer annular body of the annular body 2102 may be embedded into the groove 2201.

In some embodiments, the first winding 2103 may be wound around side walls of side columns of the plurality of first E-shaped magnetic units 2600. For example, the first winding 2103 may be wound around side walls of first side columns of the plurality of first E-shaped magnetic units 2600 that are close to the central axis. As another example, the first winding 2103 may be wound around side walls of second side columns of the plurality of first E-shaped magnetic units 2600 that are away from the central axis. In some embodiments, the second winding 2202 may be wound around side walls of intermediate columns of the plurality of second E-shaped magnetic units 2700.

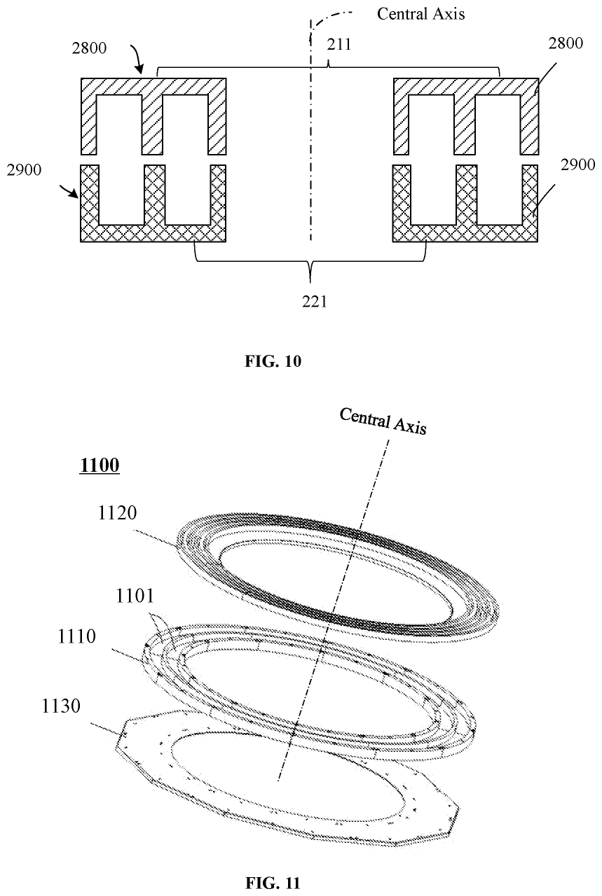

FIG. 10 is a vertical sectional view of an existing first magnetic core 211 and an exemplary second magnetic core 221 according to some embodiments of the present disclosure. As shown in FIG. 10, the first magnetic core 211 may include a plurality of third E-shaped magnetic units 2800 arranged in a circle. The second magnetic core 221 may include a plurality of fourth E-shaped magnetic units 2900 arranged in a circle. Each of the plurality of third E-shaped magnetic units 2800 and each of the plurality of fourth E-shaped magnetic units 2900 may be symmetric. For example, two side columns of each third E-shaped magnetic unit 2800 may face towards two side columns of each fourth E-shaped magnetic unit 2900. An intermediate column of each third E-shaped magnetic unit 2800 may face towards an intermediate column of each fourth E-shaped magnetic unit 2900. The first winding 2103 may be wound around side walls of intermediate columns of the plurality of first E-shaped magnetic units 2600. The second winding 2202 may be wound around side walls of intermediate columns of the plurality of fourth E-shaped magnetic units 2900.

Experiments were conducted to compare power factors and power transmission efficiencies of two power transformer 200 with different structures. The following Table 1 are recorded. E1 represents experiments conducted with an exemplary power transformer shown in FIG. 6, and E2 represents experiments conducted with an existing power transformer shown in FIG. 10. W_{gap} represents a width of a gap between the first magnetic core 211 and the second magnetic core 221. Different input voltages, input currents, and input powers are input into power transformer 200 with different structures, and the corresponding output voltages, output currents, output powers, power factors, and power transmission efficiencies are recorded.

TABLE 1

| | | Input | Input | Input | Output | Output | Output | Power | |
|---|---|---|---|---|---|---|---|---|---|
| | W_{gap} | Voltage | Current | Power | Voltage | Current | Power | Factor | Efficiency |
| E | 1 mm | 18.35 | 0.99 A | 18.16 | 20.88 | 0.39 A | 8.14 W | 0.938 | 0.448 |
| 1 | | V | | W | V | | | | |
| | 2.5 mm | 18.36 | 1.02 A | 18.73 | 20.73 | 0.39 A | 8.08 W | 0.922 | 0.389 |
| | | V | | W | V | | | | |
| E | 1 mm | 40.08 | 1.787 A | 71.62 | 34.67 | 0.65 A | 22.53 W | 0.393 | 0.314 |
| 2 | | V | | W | V | | | | |
| | 2.5 mm | 40.09 | 2.04 A | 81.78 | 30.26 | 0.56 A | 16.95 W | 0.289 | 0.207 |
| | | V | | W | V | | | | |

As shown in Table 1, for a power transformer with a same structure, a reduced width of a gap between the first magnetic core 211 and the second magnetic core 221 may improve the power factor. For example, in E1, when W_{gap}=1 mm, the power factor of the power transformer is 0.938, which is greater than 0.922 W_{gap}=2.55 mm. The same applies to E2. For power transformers with different structures, a same W_{gap}=1 mm, the power transformer shown in FIG. 9 according to some embodiments of the present disclosure has both greater power factor and greater power transmission efficiency than those of the existing power transformer shown in FIG. 10. Thus, the power transformer 200 according to some embodiments of the present disclosure has improved power transmission efficiency.

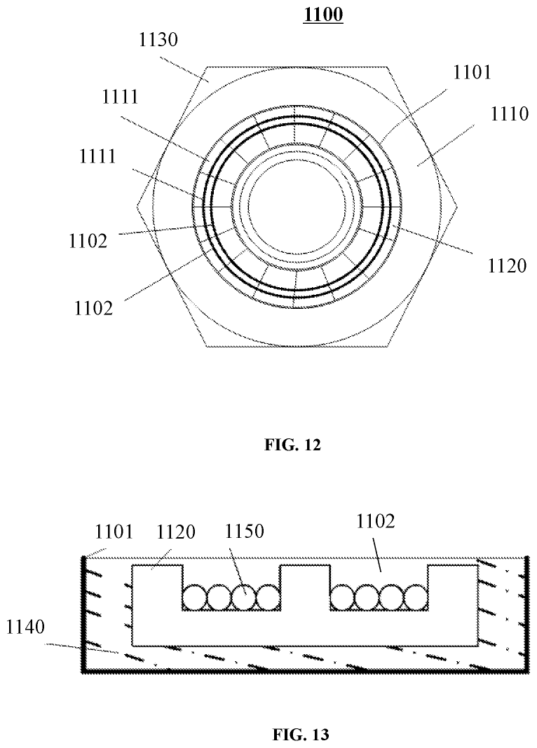

FIG. 11 is an expanded view of an exemplary magnet 1100 according to some embodiments of the present disclosure. FIG. 12 is a top view of an exemplary magnet 1100 according to some embodiments of the present disclosure. FIG. 13 is a side view of an exemplary magnetic core 1120 in a supporting piece 1110 according to some embodiments of the present disclosure. The magnet 1100 may be a first magnet 210 or a second magnet 220 described elsewhere (e.g., FIGS. 3-10) in the present disclosure. As shown in FIGS. 11-12, the magnet 1100 may include a supporting piece 1110, a magnetic core 1120, and a mounting piece 1130. The magnetic core 1120 may be a first magnetic core 211 or a second magnetic core 221 described elsewhere (e.g., FIGS. 3-10) in the present disclosure. As shown in FIG. 13, the magnet 1100 may further include a winding 1150. As shown in FIGS. 12-13, the magnet 1100 may further include at least one winding channel 1102 for accommodating the winding 1150 . The winding 1150 may be a first winding 2103 or a second winding 2202 described elsewhere (e.g., FIGS. 3-10) in the present disclosure.

In some embodiments, the magnetic core 1120 (e.g., the first magnetic core 211 or the second magnetic core 221) may include a plurality of magnetic units 1111 arranged in a circle. The plurality of magnetic units 1111 may be located into the at least one groove 1101 to form an annular magnetic core. In some embodiments, to reduce magnetic leakage of the magnetic core 1120, the plurality of magnetic units 1111 may be closely arrange. Due to error of manufacture, a distance between two adjacent magnetic units 1111 may be greater than 0.

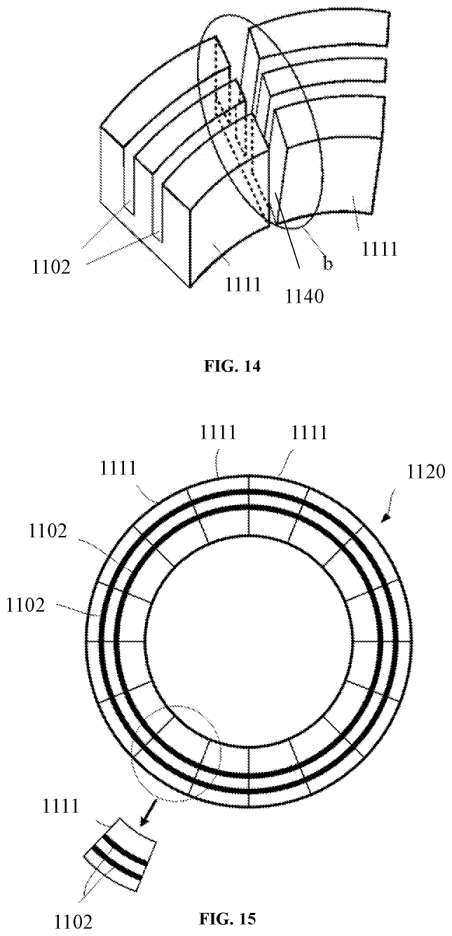

FIG. 14 is a perspective view of two exemplary adjacent magnetic units 1111 according to some embodiments of the present disclosure. As shown in FIG. 14, the distance between two adjacent magnetic units 1111 may be shown in area b. It should be noted that the distance (or the area b) between two adjacent magnetic units 1111 shown in FIG. 14 are enlarged for illustration, a real distance (or real gap) between two adjacent magnetic units 1111 is very short. In some embodiments, in order to reduce the distance two adjacent magnetic units 1111, the plurality of magnetic units 1111 of the first magnetic core 211 or the second magnetic core 221 may be bonded via a thermally conductive adhesive. For example, the thermally conductive adhesive may be injected into the aera b. Exemplary materials of the thermally conductive adhesive may include metals, metal oxides, silica, ceramic microspheres, or the like, or any combination thereof.

In some embodiments, in order to reduce the distance two adjacent magnetic units 1111, a projection of each magnetic unit 1111 of the plurality of magnetic units 1111 on a radial cross section may be a sector or a trapezoid. FIG. 15 is a top view of an exemplary magnetic core 1120 according to some embodiments of the present disclosure. As shown in FIG. 15, a projection of each magnetic unit 1111 of the magnetic core 1120 on the radial cross section of the magnetic core 1120 is a sector. An inside surface of the sector that is close to the central axis is a circular arcs and an outside surface of the sector that is away from the central axis is a circular arcs. The plurality of magnetic units 1111 may be closely fitted due to the sector-shaped projection of each magnetic unit 1111.

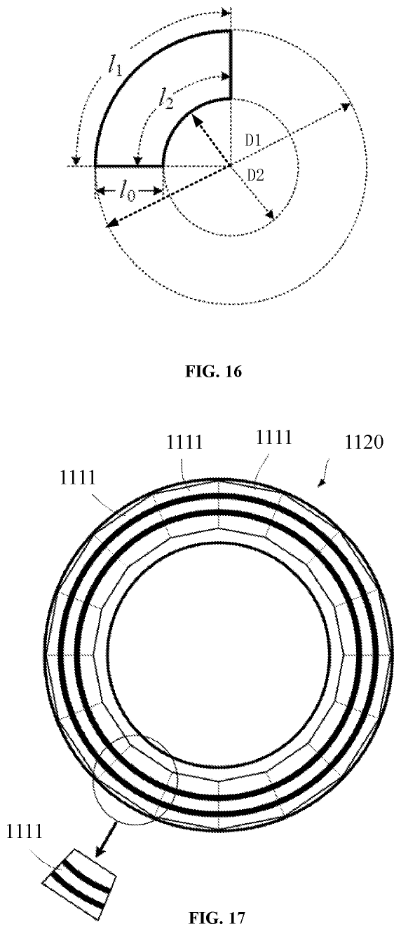

FIG. 16 is a schematic diagram illustrating an exemplary magnetic core 1120 according to some embodiments of the present disclosure. As shown in FIG. 16, when the magnetic core 1120 is annular, a count of the plurality of magnetic units 1111 each of which has a sector-shaped projection may be determined by following equations (1)-(3):

nl₁=πD1 (1),

nl₂=πD2 (2),

D1=D2+2l₀ (3),

where n denotes the count of the plurality of magnetic units 1111, l₁ denotes an outer arc length of a magnetic unit 1111, D1 denotes an outside diameter of the magnetic core 1120, l₂ denotes an inner arc length of the magnetic unit 1111, D2 denotes an inner diameter of the magnetic core 1120, and l₀ denotes a difference between the outside diameter and the inner diameter of the magnetic core 1120.

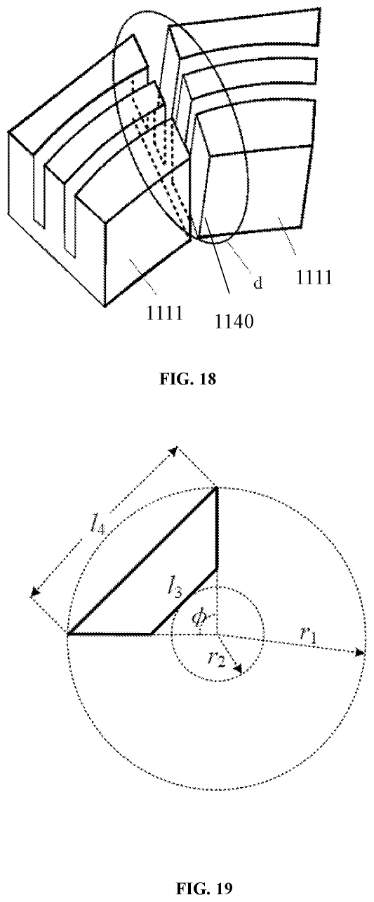

FIG. 17 is a top view of an exemplary magnetic core 1120 according to some embodiments of the present disclosure. FIG. 18 is a perspective view of two exemplary adjacent magnetic units 1111 according to some embodiments of the present disclosure. As shown in FIGS. 17-18, a projection of each magnetic unit 1111 of the magnetic core 1120 on a radial cross section is a trapezoid. An inside surface of the sector that is close to the central axis is flat and an outside surface of the sector that is away from the central axis is flat. The plurality of magnetic units 1111 may be closely fitted due to the trapezoid-shaped projection of each magnetic unit 1111. As shown in FIG. 18, the distance between two adjacent magnetic units 1111 may be shown in area d. It should be noted that the distance (or the area d) between two adjacent magnetic units 1111 shown in FIG. 18 are enlarged for illustration, a real distance (or real gap) between two adjacent magnetic units 1111 is very short. In some embodiments, in order to reduce the distance two adjacent magnetic units 1111, the plurality of magnetic units 1111 of the first magnetic core 211 or the second magnetic core 221 may be bonded via a thermally conductive adhesive. For example, the thermally conductive adhesive may be injected into the aera d. Exemplary materials of the thermally conductive adhesive may include metals, metal oxides, silica, ceramic microspheres, or the like, or any combination thereof.

FIG. 19 is a schematic diagram illustrating an exemplary magnetic core 1120 according to some embodiments of the present disclosure. As shown in FIG. 19, when the magnetic core 1120 is annular, a count of the plurality of magnetic units 1111 each of which has a trapezoid-shaped projection may be determined by following equations (4)-(6):

l₃=2r₂*tan(φ/2) (4),

l₄=2r₁*tan(φ/2) (5),

n=360°/φ (6),

where n denotes the count of the plurality of magnetic units 1111, l₃ denotes a length of a top edge of a magnetic unit 1111, l₄ denotes a length of a bottom edge of the magnetic unit 1111, r₂ denotes an inner diameter of the magnetic core 1120, r₁ denotes an outer diameter of the magnetic core 1120, and φ denotes a central angle of the bottom edge of the magnetic unit 1111.

In some embodiments, each of the plurality of magnetic units 1111 may include at least one slot, and when the plurality of magnetic units 1111 are arranged in a circle, a plurality of slots of the plurality of magnetic units 1111 may be connected to form the at least one winding channel 1102. In some embodiments, the plurality of magnetic units may include at least one of: an E-shaped magnetic unit, a U-shaped magnetic unit, or a L-shaped magnetic unit. For example, as shown in FIG. 14, the plurality of magnetic units 1111 may include E-shaped magnetic units. The two side columns and the intermediate column of each E-shaped magnetic unit form two slots, and two slots of every two adjacent magnetic units 1111 are connected to form two winding channels 1102. As another example, the plurality of magnetic units 1111 may include U-shaped magnetic units. A U-shaped slot of each U-shaped magnetic unit is connected to form a winding channel 1102. As used herein, the E-shaped magnetic unit or the U-shaped magnetic unit may refer to a section view along a plane parallel to the axial direction is an E-shape or a U-shape. The plane parallel to the axial direction may be a plane of a central axis and a radial direction of the magnet 1100.

In some embodiments, the plurality of magnetic units 1111 may have a same size or different sizes. In some embodiments, the plurality of magnetic units 1111 may have a same shape or different shapes. For example, to reduce the magnetic leakage of the magnet 1100 and for ease of manufacture, the plurality of magnetic units 1111 may have a same size and/or a same shape. As another example, the plurality of magnetic units 1111 may have a same shape and different sizes.

In some embodiments, a count of the plurality of magnetic units 1111 may be determined based on a requirement of the electronic device 400. For example, if the electronic device 400 is a CT imaging device, the count of the plurality of magnetic units 1111 may be determined based on a size of an inner diameter of a scanning hole (e.g., the gantry) of the CT imaging device. For example, the count of the plurality of magnetic units 1111 may be at least two. For example, the plurality of magnetic units 1111 may include two semicircular magnetic units.

The supporting piece 1110 may be configured to support the magnetic core 1120 (or the plurality of magnetic units 1111). As shown in FIGS. 11-13, the supporting piece 1110 may include at least one groove 1101 for accommodating, fixing, and limiting the magnetic core 1120 (or the plurality of magnetic units 1111). In some embodiments, the at least one groove 1101 may be at least one annular groove. A groove 1101 may be a groove 2201 described elsewhere (e.g., FIGS. 3-10) in the present disclosure. In some embodiments, for ease of installation, a size of the at least one groove 1101 may be greater than that of the magnetic core 1120 (or the plurality of magnetic units 1111). In some embodiments, to fixed the plurality of magnetic units 1111 in the supporting piece 1110, the at least one groove 1101 may be injected with a thermally conductive adhesive. For example, as shown in FIG. 13, a thermally conductive adhesive 1140 may be arranged inside, outside, and bottom of the magnetic core 1120 to reduce the magnetic leakage.

In some embodiments, the mounting piece 1130 may be configured to mount the magnet 1100 to an external device. For example, the mounting piece 1130 may connect the power transformer (or the magnet 1100) to an electronic device (e.g., the electronic device 400). In some embodiments, the supporting piece 1110 may be fixedly arranged on the mounting piece 1130. For example, the supporting piece 1110 may be fixedly arranged on the mounting piece 1130 by nuts and bolts.

It should be noted that the shapes of the supporting piece 1110 and/or the mounting piece 1130 may be not limited to circle. The supporting piece 1110 and/or the mounting piece 1130 may also have other shapes, such as a polygon. In some embodiments, a material of the supporting piece 1110 and/or the mounting piece 1130 may include stainless steel.

According to some embodiments of the present disclosure, the plurality of magnetic units 1111 are arranged in a circle to form the annular magnetic core 1120. Compared with an integrally-formed magnetic core, the magnetic core 1120 including the plurality of magnetic units 1111 are easy to manufacture. The plurality of magnetic units 1111 are mounted in the supporting piece 1110, which reduces an installation difficulty of the magnetic core 1120. Further, the plurality of magnetic units 1111 are connected via the thermally conductive adhesive, the magnetic leakage is reduced and the power transmission efficiency is improved.

It should be noted that the above description is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by this disclosure, and are within the spirit and scope of the exemplary embodiments of this disclosure.

Moreover, certain terminology has been used to describe embodiments of the present disclosure. For example, the terms “one embodiment,” “an embodiment,” and/or “some embodiments” mean that a particular feature, structure or characteristic described in connection with the embodiment is included in at least one embodiment of the present disclosure. Therefore, it is emphasized and should be appreciated that two or more references to “an embodiment” or “one embodiment” or “an alternative embodiment” in various portions of this specification are not necessarily all referring to the same embodiment. Furthermore, the particular features, structures or characteristics may be combined as suitable in one or more embodiments of the present disclosure.

Further, it will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “unit,” “module,” or “system.” Furthermore, aspects of the present disclosure may take the form of a computer program product embodied in one or more computer readable media having computer readable program code embodied thereon.

A non-transitory computer readable signal medium may include a propagated data signal with computer readable program code embodied therein, for example, in baseband or as part of a carrier wave. Such a propagated signal may take any of a variety of forms, including electro-magnetic, optical, or the like, or any suitable combination thereof. A computer readable signal medium may be any computer readable medium that is not a computer readable storage medium and that may communicate, propagate, or transport a program for use by or in connection with an instruction execution system, apparatus, or device. Program code embodied on a computer readable signal medium may be transmitted using any appropriate medium, including wireless, wireline, optical fiber cable, RF, or the like, or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C #, VB. NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Furthermore, the recited order of processing elements or sequences, or the use of numbers, letters, or other designations therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose, and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software only solution, e.g., an installation on an existing server or mobile device.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various inventive embodiments. This method of disclosure, however, is not to be interpreted as reflecting an intention that the claimed subject matter requires more features than are expressly recited in each claim. Rather, inventive embodiments lie in less than all features of a single foregoing disclosed embodiment.

In some embodiments, the numbers expressing quantities, properties, and so forth, used to describe and claim certain embodiments of the application are to be understood as being modified in some instances by the term “about,” “approximate,” or “substantially.” For example, “about,” “approximate,” or “substantially” may indicate ±20% variation of the value it describes, unless otherwise stated. Accordingly, in some embodiments, the numerical parameters set forth in the written description and attached claims are approximations that may vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the application are approximations, the numerical values set forth in the specific examples are reported as precisely as practicable.

Each of the patents, patent applications, publications of patent applications, and other material, such as articles, books, specifications, publications, documents, things, and/or the like, referenced herein is hereby incorporated herein by this reference in its entirety for all purposes, excepting any prosecution file history associated with same, any of same that is inconsistent with or in conflict with the present document, or any of same that may have a limiting affect as to the broadest scope of the claims now or later associated with the present document. By way of example, should there be any inconsistency or conflict between the description, definition, and/or the use of a term associated with any of the incorporated material and that associated with the present document, the description, definition, and/or the use of the term in the present document shall prevail.

In closing, it is to be understood that the embodiments of the application disclosed herein are illustrative of the principles of the embodiments of the application. Other modifications that may be employed may be within the scope of the application. Thus, by way of example, but not of limitation, alternative configurations of the embodiments of the application may be utilized in accordance with the teachings herein. Accordingly, embodiments of the present application are not limited to that precisely as shown and described.

1. A power transformer, comprising:
a first magnet comprising a first magnetic core and a first winding, wherein the first magnetic core includes an annular body, and the first winding is wound around a side wall of the annular body; and
a second magnet comprising a second magnetic core and a second winding wound around a side wall of the second magnetic core, wherein the second magnetic core includes a groove extending from an end surface of the second magnetic core; wherein
the first magnet and the second magnet are contactless;
at least part of the annular body is embedded in the groove; and
the first winding and the second winding are at least partially overlapped along an axial direction of the second magnetic core.

2. The power transformer of claim 1, wherein the first magnetic core or the second magnetic core includes a plurality of magnetic units arranged in a circle.

3. The power transformer of claim 2, wherein the plurality of magnetic units includes at least one of: an E-shaped magnetic unit, a U-shaped magnetic unit, or a L-shaped magnetic unit.

4. The power transformer of claim 2, wherein the first magnetic core includes a plurality of first L-shaped magnetic units arranged in a circle, wherein
long ends of the plurality of first L-shaped magnetic units form the annular body; and
short ends of the plurality of first L-shaped magnetic units form the annular plate.

5. The power transformer of claim 4, wherein the second magnetic core includes a plurality of first U-shaped magnetic units arranged in a circle to form the groove, wherein the second winding is wound around at least one of:
a side wall of the groove of the second magnetic core,
a side wall of an inner ring of the second magnetic core, or
a side wall of an outer ring of the second magnetic core.

6. The power transformer of claim 4, wherein the second magnetic core includes a plurality of second L-shaped magnetic units arranged in a circle to form the groove, wherein the second winding is wound around a side wall of the groove.

7. The power transformer of claim 2, wherein the first magnetic core includes a plurality of second U-shaped magnetic units arranged in a circle, wherein
inner ends of the plurality of second U-shaped magnetic units form an inner annular body of the annular body; and
outer ends of the plurality of second U-shaped magnetic units form an outer annular body of the annular body.

8. The power transformer of claim 7, wherein the inner annular body or the outer annular body is embedded in the groove, and the first winding is wound around a side wall of the inner annular body or a side wall of the outer annular body.

9. The power transformer of claim 7, wherein the second magnetic core includes a plurality of third U-shaped magnetic units arranged in a circle to form the groove, wherein the second winding is wound around at least one of:
a side wall of the groove of the second magnetic core,
a side wall of an inner ring of the second magnetic core, or
a side wall of an outer ring of the second magnetic core.

10. The power transformer of claim 2, wherein the first magnetic core includes a plurality of first E-shaped magnetic units arranged in a circle, wherein the first winding is wound around side walls of side columns of the plurality of first E-shaped magnetic units (2600).

11. The power transformer of claim 10, wherein the second magnetic core includes a plurality of second E-shaped magnetic units arranged in a circle, wherein the second winding is wound around side walls of intermediate columns of the plurality of second E-shaped magnetic units, and the side columns of the plurality of first E-shaped magnetic units are embedded in slots of the plurality of second E-shaped magnetic units.

12. The power transformer of claim 1, wherein the first magnetic core further includes an annular plate disposed on a top end of the annular body, wherein
a bottom end of the annular body is embedded in the groove; and
an outer diameter of the annular plate is greater than an outer diameter of the annular body.

13. The power transformer of claim 2, wherein the plurality of magnetic units of the first magnetic core or the second magnetic core are bonded via a thermally conductive adhesive.

14. The power transformer of claim 2, wherein a projection of each magnetic unit of the plurality of magnetic units on a radial cross section is a sector or a trapezoid.

15. The power transformer of claim 2, wherein the plurality of magnetic units have a same size or a same shape.

16. The power transformer of claim 2, wherein the first magnetic core or the second magnetic core includes at least one winding channel.

17. The power transformer of claim 2, further comprising a supporting piece for supporting the plurality of magnetic units.

18. (canceled)

19. The power transformer of claim 1, wherein a winding of a transmitter connects an alternating current (AC) power supply, and a winding of a receiver connects an electronic device, wherein
when the first magnet is the transmitter, the second magnet is the receiver, and
when the second magnet is the transmitter, the first magnet is the receiver.

20-22. (canceled)

23. A power transformer, comprising:
a first magnet comprising a first magnetic core and a first winding; and
a second magnet comprising a second magnetic core and a second winding; wherein
the first magnet and the second magnet are contactless;
the first magnetic core or the second magnetic core includes a plurality of magnetic units arranged in a circle.

24. A medical device, comprising a power transformer, wherein the power transformer includes:
a first magnet comprising a first magnetic core and a first winding, wherein the first magnetic core includes an annular body, and the first winding is wound around a side wall of the annular body; and
a second magnet comprising a second magnetic core and a second winding wound around a side wall of the second magnetic core, wherein the second magnetic core includes a groove extending from an end surface of the second magnetic core; wherein
the first magnet and the second magnet are contactless;
at least part of the annular body is embedded in the groove; and
the first winding and the second winding are at least partially overlapped along an axial direction of the second magnetic core.
